(19) United States
(12) Patent Application Publication
(10) Pub. No.: US 2018/0026694 A1
(43) Pub. Date: Jan. 25, 2018

(54) METHOD AND APPARATUS FOR COMMUNICATION BASED ON COMMON FEEDBACK INFORMATION IN MULTIPLE ANTENNA SYSTEM

(71) Applicant: LG ELECTRONICS INC., Seoul (KR)

(72) Inventors: Hyunsoo KO, Seoul (KR); Heejeong CHO, Seoul (KR); Hyeyoung CHOI, Seoul (KR); Ilmu BYUN, Seoul (KR); Kungmin PARK, Seoul (KR)

(21) Appl. No.: 15/550,692

(22) PCT Filed: Feb. 13, 2015
(86) PCT No.: PCT/KR2015/001473

§ 371 Date: Aug. 11, 2017

(51) Int. Cl. H04B 7/06

(52) U.S. Cl. CPC H04B 7/0617; H04B 7/0667; H04B 7/0632; H04B 7/0645

(57) ABSTRACT

Disclosed is method and apparatus for communication using common feedback information in multiple antenna system. According to this method, a receiving side device receives rank Ni signals from a transmitting side device with a first type multiple antenna transmission scheme at a first receiving opportunity, and receives rank Nj signals from the transmitting side device with a second type multiple antenna transmission scheme at a second receiving opportunity, where Ni>Nj. The feedback information of this method is common feedback information comprising a combination of a first feedback information for the rank Ni signals and a second feedback information for the rank Nj signals. For this, the first type multiple antenna transmission scheme uses the second type multiple antenna transmission scheme for transmission of rank Nj signals among the rank Ni signals received at the first receiving opportunity.

### TECHNICAL FIELD

The present invention relates to a multiple antenna system in a wireless communication system, and more particularly, to a method and apparatus for communication based on common feedback information in multiple antenna system.

### BACKGROUND ART

As one example of a wireless communication system to be improved by having the present invention apply thereto, 3GPP LTE (3^{rd} generation partnership project long term evolution) (hereinafter abbreviated LTE) communication system is schematically described as follows.

FIG. 1 is a schematic diagram of E-UMTS network structure as an example of a wireless communication system. E-UMTS (evolved universal mobile telecommunications system) is the system evolved from a conventional UMTS (universal mobile telecommunications system) and its basic standardization is progressing by 3GPP. Generally, E-UMTS can be called LTE (long term evolution) system. For the details of the technical specifications of UMTS and E-UMTS, Release 7 and Release 8 of ‘3rd Generation Partnership Project: Technical Specification. Group Radio Access Network’ can be referred to.

Referring to FIG. 1, E-UMTS consists of a user equipment (UE) 120, base stations (eNode B: eNB) 110a and 110b and an access gateway (AG) provided to an end terminal of a network (E-UTRAN) to be connected to an external network. The base station is able to simultaneously transmit multi-data stream for a broadcast service, a multicast service and/or a unicast service.

At least one or more cells exist in one base station. The cell is set to one of bandwidths including 1.25 MHz, 2.5 MHz, 5 MHz, 10 MHz, 15 MHz, 20 MHz and the like and then provides an uplink or downlink transmission service to a plurality of user equipments. Different cells can be set to provide different bandwidths, respectively. A base station controls data transmissions and receptions for a plurality of user equipments. A base station sends downlink scheduling information on downlink (DL) data to inform a corresponding user equipment of time/frequency region for transmitting data to the corresponding user equipment, coding, data size, HARQ (hybrid automatic repeat and request) relevant information and the like. And, the base station sends uplink scheduling information on uplink (UL) data to a corresponding user equipment to inform the corresponding user equipment of time/frequency region available for the corresponding user equipment, coding, data size, HARQ relevant information and the like. An interface for a user traffic transmission or a control traffic transmission is usable between base stations. A core network (CN) can consist of an AG, a network node for user registration of a user equipment and the like. The AG manages mobility of the user equipment by a unit of TA (tracking area) including a plurality of cells.

The wireless communication technology has been developed up to LTE based on WCDMA but the demands and expectations of users and service providers are continuously rising. Since other radio access technologies keep being developed, new technological evolution is requested to become competitive in the future.

### DISCLOSURE

### Technical Task

In the following description, efficient spatial modulation schemes for addressing the above problem are proposed.

Technical tasks obtainable from the present invention are non-limited the above-mentioned technical task. And, other unmentioned technical tasks can be clearly understood from the following description by those having ordinary skill in the technical field to which the present invention pertains.

### Technical Solution

In one technical aspect of the present invention, provided herein is a method for a transmitting side device to transmit signals with multiple antennas in a wireless communication system, the method comprising: transmitting rank Ni signals to a receiving side device with a first type multiple antenna transmission scheme at a first transmission opportunity; receiving feedback information from the receiving side device in response to the transmitted rank Ni signals; transmitting rank Nj signals to the receiving side device with a second type multiple antenna transmission scheme at a second transmission opportunity, wherein Ni>Nj, wherein the first type multiple antenna transmission scheme uses the second type multiple antenna transmission scheme for transmitting rank Nj signals among the transmitted rank Ni signals at the first transmission opportunity, and wherein transmitting the Nj signals at the second transmission opportunity is based on a consideration of a part of the feedback information received in response to the rank Ni signals transmitted at the first transmission opportunity.

When Ni is 2 and Nj is 1, the first type multiple antenna transmission scheme may be dual stream beamforming, and the second type multiple antenna scheme may be Alamouti transmission based on the dual stream beamforming.

The first type multiple antenna transmission scheme may use a first precoder corresponding to a first precoding matrix, and the second type of multiple antenna transmission scheme may use a second precoder corresponding to a second precoding matrix. In this case, the first precoding matrix may comprise all of columns of the second precoding matrix.

The above feedback information may comprises: an index indicating the first precoding matrix, channel quality information for the rank Ni signals, and channel quality information for the rank Nj signals.

The feedback information may comprise a combination of a first feedback information for the rank Ni signals and a second feedback information for the rank Nj signals.

The transmitting side device may comprise Nk transmission antennas, and Ni is an integer from 2 to Nk.

The transmitting side device may be a base station employing a massive MIMO scheme.

In another aspect of the present invention, a method for a receiving side device to transmit feedback information in a wireless communication system, the method comprising: receiving rank Ni signals from a transmitting side device with a first type multiple antenna transmission scheme at a first receiving opportunity; receiving rank Nj signals from the transmitting side device with a second type multiple antenna transmission scheme at a second receiving opportunity, wherein Ni>Nj; and transmitting feedback information to the transmitting side device, wherein the first type multiple antenna transmission scheme uses the second type multiple antenna transmission scheme for transmission of rank Nj signals among the rank Ni signals received at the first receiving opportunity, and wherein the feedback information comprises a combination of a first feedback information for the rank Ni signals and a second feedback information for the rank Nj signals, is provided.

The first type multiple antenna transmission scheme may use a first precoder corresponding to a first precoding matrix, and the second type of multiple antenna transmission scheme may use a second precoder corresponding to a second precoding matrix. In this case, the first precoding matrix may comprise all of columns of the second precoding matrix.

In another aspect of the present invention, a transmitting side device for transmitting signals in a wireless communication system, the device comprising: multiple antennas; a RF unit in connection with the multiple antennas; and a processor connected to the RF unit and configured to control the RF unit to transmit rank Ni signals with a first type multiple antenna transmission scheme, and to transmit rank Nj signals with a second type multiple antenna transmission scheme, and to receive feedback information from a receiving side device, wherein Ni>Nj, wherein the first type multiple antenna transmission scheme uses the second type multiple antenna transmission scheme for transmitting rank Nj signals among the rank Ni signals at a transmission of the rank Ni signals, and wherein transmitting independent Nj signals is based on a consideration of a part of the feedback information received in response to the previously transmitted rank Ni signals, is provided.

In another aspect of the present invention, a receiving side device for transmitting feedback information in a wireless communication system, the device comprising: a RF unit receiving rank Ni signals from a transmitting side device with a first type multiple antenna transmission scheme, and receiving rank Nj signals from the transmitting side device with a second type multiple antenna transmission scheme, wherein Ni>Nj; and transmitting feedback information to the transmitting side device, wherein the first type multiple antenna transmission scheme uses the second type multiple antenna transmission scheme for transmission of rank Nj signals among the rank Ni signals; and a processor connected to the RF unit and configured to construct the feedback information to comprise a combination of a first feedback information for the rank Ni signals and the rank Nj signals, is provided.

### Advantageous Effects

According to the present invention, wireless communication can enjoy the efficient communication based on common feedback information. For example, the signaling overhead and delay due to the feedback procedure will be reduced.

Effects obtainable from the present invention may be non-limited by the above-mentioned effects. And, other effects not recited can be clearly understood from the following description by those having ordinary skill in the technical field to which the present invention pertains.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a schematic block diagram of E-UMTS network structure as one example of a wireless communication system.

FIG. 2 is a diagram of structures of control and user planes of a radio interface protocol between a user equipment and E-UTRAN based on 3GPP radio access network specification.

FIG. 3 is a diagram for explaining physical channels used by 3GPP system and a general signal transmitting method using the same.

FIG. 4 is a diagram for a configuration of a general multi-antenna (MIMO) communication system.

FIG. 5 is a diagram for explaining the use of common feedback information according to one embodiment of the present application.

FIG. 6 is a diagram for explaining the sub-combination relationship between the first and the second multiple antenna transmission schemes.

FIG. 7 is a diagram for explaining the reduction of feedback information according to one embodiment of the present invention.

FIG. 8 is a diagram for explaining another example of present invention.

FIG. 9 is a block diagram for a configuration of a communication device according to one embodiment of the present invention.

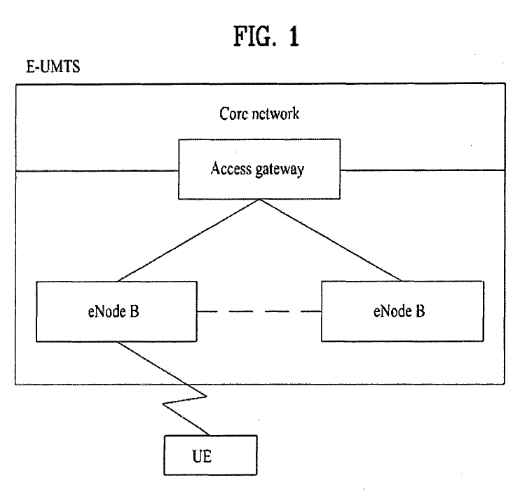

### MODE FOR INVENTION

### Best Mode for Invention

Reference will now be made in detail to the preferred embodiments of the present invention, examples of which are illustrated in the accompanying drawings. In the following detailed description of the invention includes details to facilitate the full understanding of configurations, functions and other features of the present invention. The embodiments mentioned in the following description include the examples of applying the technical features of the invention to 3GPP systems.

Although embodiments of the invention are described in the present specification using LTE system and LTE-A system for example, they are applicable to any communication systems corresponding to the above definitions.

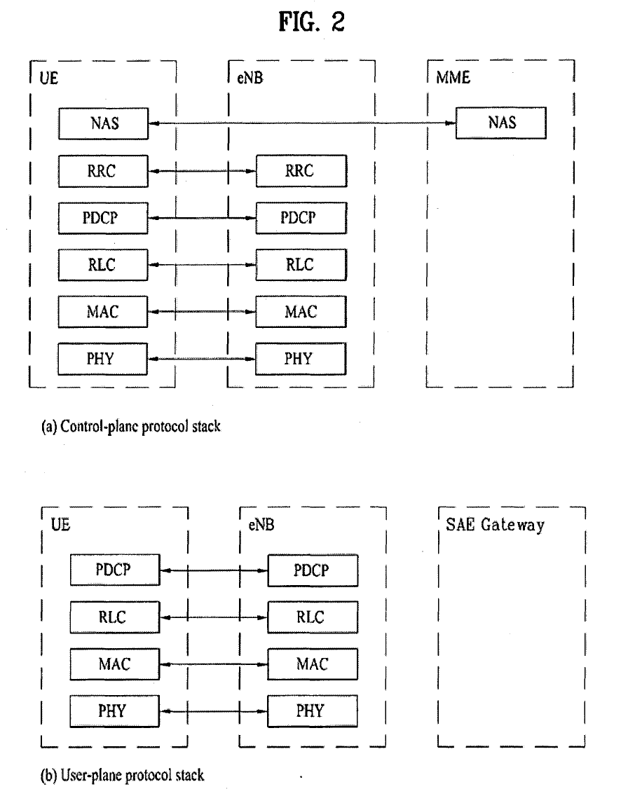

FIG. 2 is a diagram of structures of control and user planes of a radio interface protocol between a user equipment and E-UTRAN based on 3GPP radio access network specification.

First of all, a control plane means a passage for transmitting control messages used by a user equipment and a network to manage a call. A user plane means a passage for transmitting such data generated from an application layer as voice data, internet packet data and the like.

A physical layer, i.e., a first layer, provides an information transfer service to an upper layer using a physical channel. The physical layer is connected to a medium access control layer located above via a transport channel. Data are transferred between the medium access control layer and the physical layer via the transport channel. Data are transferred between a physical layer of a transmitting side and a physical layer of a receiving side via a physical channel. The physical channel uses time and frequency as radio resources. In particular, a physical layer is modulated in downlink by OFDMA (orthogonal frequency division multiple access) scheme and is modulated in uplink by SC-FDMA (single carrier frequency division multiple access) scheme.

A medium access control (hereinafter abbreviated MAC) layer of a second layer provides a service to a radio link control (hereinafter abbreviated RLC) layer of an upper layer via a logical channel. The RLC layer of the second layer supports reliable data transfer. A function of the RLC layer can be implemented using a function block within the MAC. A packet data convergence protocol (hereinafter abbreviated PDCP) layer of the second layer performs a header compression function for reducing unnecessary control information to transmit such an IP packet as IPv4 and IPv6 in a radio interface having a narrow bandwidth.

A radio resource control (hereinafter abbreviated RRC) layer located on a lowest level of a third layer is defined in a control plane only. The RRC layer is responsible for controlling logical channel, transport channel and physical channels in association with configuration, reconfiguration and release of radio bearers (RBs). In this case, the RB means a service provided by the second layer for a data transfer between a user equipment and a network. For this, the RRC layer of the user equipment exchanges RRC messages with the RRC layer of the network. In case that an RRC connection is established between an RRC layer of a user equipment and an RRC layer of a network, the user equipment is in a connected mode. Otherwise, the user equipment is in an idle mode. NAS (non-access stratum) layer above an RRC layer performs a function of session management, a function of mobility management and the like.

A downlink transport channel for transporting data to a user equipment from a network includes a broadcast channel (BCH) for transporting system information, a paging channel (PCH) for transmitting a paging message, a downlink shared channel (SCH) for transmitting a user traffic or a control message or the like. A traffic or control message of a downlink multicast or broadcast service can be transmitted via a downlink SCH or a separate downlink multicast channel (MCH). Meanwhile, an uplink transport channel for transmitting data from a user equipment to a network includes a random access channel for transmitting an initial control message, an uplink shared channel (SCH) for transmitting a user traffic or a control message or the like. A logical channel located above a transport channel to be mapped by a transport channel includes BCCH (Broadcast Control Channel), PCCH (Paging Control Channel), CCCH (Common Control Channel), MCCH (Multicast Control Channel), MTCH (Multicast Traffic Channel) or the like.

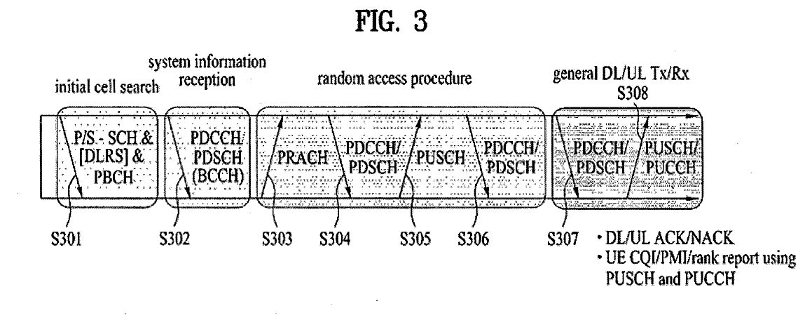

FIG. 3 is a diagram for explaining physical channels used by 3GPP system and a general signal transmitting method using the same.

Referring to FIG. 3, if a power of a user equipment is turned on or the user equipment enters a new cell, the user equipment performs an initial cell search for matching synchronization with a base station and the like [S301]. For this, the user equipment receives a primary synchronization channel (P-SCH) and a secondary synchronization channel (S-SCH) from the base station, matches synchronization with the base station and then obtains information such as a cell ID and the like. Subsequently, the user equipment receives a physical broadcast channel from the base station and is then able to obtain intra-cell broadcast information. Meanwhile, the user equipment receives a downlink reference signal (DL RS) in the initial cell searching step and is then able to check a downlink channel status.

Having completed the initial cell search, the user equipment receives a physical downlink control channel (PDCCH) and a physical downlink shared control channel (PDSCH) according to information carried on the physical downlink control channel (PDCCH) and is then able to obtain system information in further detail [S302].

Meanwhile, if the user equipment initially accesses the base station or fails to have a radio resource for signal transmission, the user equipment is able to perform a random access procedure (RACH) on the base station [S303 to S306]. For this, the user equipment transmits a specific sequence as a preamble via a physical random access channel (PRACH) [S303, S305] and is then able to receive a response message via PDCCH and a corresponding PDSCH in response to the preamble [S304, S306]. In case of contention based RACH, it is able to perform a contention resolution procedure in addition.

Having performed the above mentioned procedures, the user equipment is able to perform PDCCH/PDSCH reception [S307] and PUSCH/PUCCH (physical uplink shared channel/physical uplink control channel) transmission [S308] as a general uplink/downlink signal transmission procedure. In particular, the user equipment receives a downlink control information (DCI) via PDCCH. In this case, the DCI includes such control information as resource allocation information on a user equipment and can differ in format in accordance with the purpose of its use.

Meanwhile, control information transmitted/received in uplink/downlink to/from the base station by the user equipment includes ACK/NACK signal, CQI (channel quality indicator), PMI (precoding matrix index), RI (rank indicator) and the like. In case of the 3GPP LTE system, the user equipment is able to transmit the above mentioned control information such as CQI, PMI, RI and the like via PUSCH and/or PUCCH.

In the following description, MIMO system is explained. First of all, MIMO (multi-input multi-output) is a method that uses a plurality of transmitting antennas and a plurality of receiving antennas. And, this method may be able to improve efficiency in transceiving data. In particular, a transmitting or receiving stage of a wireless communication system uses a plurality of antennas to increase capacity or enhance performance. In the following description, the MIMO may be called ‘multiple antennas (multi-antenna)’.

The MIMO technology does not depend on a single antenna path to receive one whole message. Instead, the MIMO technique completes data by putting fragments received via several antennas together. If the MIMO technique is adopted, a data transmission rate within a cell area having a specific size may be improved or a system coverage may be increased by securing a specific data transmission rate. Moreover, this technique may be widely applicable to a mobile communication terminal, a relay and the like. According to the MIMO technique, it may be able to overcome the transmission size limit of the related art mobile communication which used to use a single data.

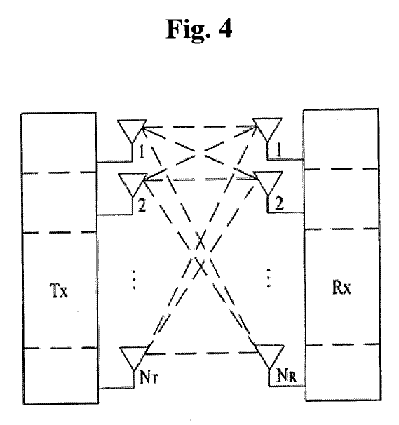

FIG. 4 is a diagram for a configuration of a general multi-antenna (MIMO) communication system.

N_{T} transmitting antennas are provided to a transmitting stage, while N_{R} receiving antennas are provided to a receiving stage. In case that each of the transmitting and receiving stages uses a plurality of antennas, theoretical channel transmission capacity is increased more than that of a case that either the transmitting stage or the receiving stage uses a plurality of antennas. The increase of the channel transmission capacity is in proportion to the number of antennas. Hence, a transmission rate is enhanced and frequency efficiency can be raised. Assuming that a maximum transmission rate in case of using a single antenna is set to R₀, the transmission rate in case of using multiple antennas may be theoretically raised by a result from multiplying the maximum transmission rate R₀ by a rate increasing rate Rᵢ, as shown in Formula 1. In this case, Rᵢ is a smaller one of N_{T} and N_{R}.

Rᵢ=min(N_{T},N_{R}) [Formula 1]

For instance, in an MIMO communication system, which uses 4 transmitting antennas and 4 receiving antennas, it may be able to obtain a transmission rate 4 times higher than that of a single antenna system. After this theoretical capacity increase of the MIMO system has been proved in the middle of 90's, many ongoing efforts are made to various techniques to substantially improve a data transmission rate. And, these techniques are already adopted in part as standards for the 3G mobile communications and various wireless communications such as a next generation wireless LAN and the like.

The trends for the MIMO relevant studies are explained as follows. First of all, many ongoing efforts are made in various aspects to develop and research information theory study relevant to MIMO communication capacity calculations and the like in various channel configurations and multiple access environments, radio channel measurement and model derivation study for MIMO systems, spatiotemporal signal processing technique study for transmission reliability enhancement and transmission rate improvement and the like.

In order to explain a communicating method in an MIMO system in detail, mathematical modeling can be represented as follows. Referring to FIG. 4, assume that N_{T} transmitting antennas and N_{R} receiving antennas exist. First of all, regarding a transmission signal, if there are N_{T} transmitting antennas, N_{T} maximum transmittable informations exist. Hence, the transmission information may be represented by the vector shown in Formula 2.

s=[s₁,s₂, . . . ,s_{N}_{_{T}}]^{T} [Formula 2]

Meanwhile, transmission powers can be set different from each other for transmission informations s₁,s₂, . . . , s_{N}_{_{T}}, respectively. If the transmission powers are set to P₁,P₂, . . . , P_{N}_{_{T}}, respectively, the transmission power adjusted transmission information can be represented as Formula 3.

ŝ=[ŝ₁,ŝ₂, . . . ,ŝ_{N}_{_{T}}]^{T}=[P₁s₁,P₂s₂, . . . ,P_{N}_{_{T}}s_{N}_{_{T}}]^{T} [Formula 3]

And, Ŝ may be represented as Formula 4 using a diagonal matrix P of the transmission power.

$$\hat{s} = [ \begin{matrix}{P}_{1} & & & 0 \\ & {P}_{2} & & \\ & & ⋱ & \\ 0 & & & {P}_{{N}_{T}}\end{matrix} ] [ \begin{matrix}{s}_{1} \\ {s}_{2} \\ ⋮ \\ {s}_{{N}_{T}}\end{matrix} ] = Ps \qquad [ Formula 4 ]$$

Let us consider a case of configuring N_{T} transmitted signals x₁,x₂, . . . , x_{N}_{_{T}}, which are actually transmitted, by applying a weight matrix W to a transmission power adjusted information vector Ŝ. In this case, the weight matrix plays a role in properly distributing transmission information to each antenna according to a transmission channel status and the like. The transmitted signals are set to x₁,x₂, . . . , x_{N}_{_{T}} may be represented as Formula 5 using a vector X. In this case, Wᵢⱼ means a weight between an i^{th} transmitting antenna and a j^{th} information. And, the W may be called a weight matrix or a precoding matrix.

$$x = [ \begin{matrix}{x}_{1} \\ {x}_{2} \\ ⋮ \\ {x}_{i} \\ ⋮ \\ {x}_{{N}_{T}}\end{matrix} ] = [ \begin{matrix}{w}_{11} & {w}_{12} & … & {W}_{1 {N}_{T}} \\ {w}_{21} & {w}_{22} & … & {w}_{2 {N}_{T}} \\ ⋮ & & ⋱ & \\ {w}_{i 1} & {w}_{i 2} & … & {w}_{{iN}_{T}} \\ ⋮ & & ⋱ & \\ {w}_{{N}_{T} 1} & {w}_{{N}_{T} 2} & … & {w}_{{N}_{T} {N}_{T}}\end{matrix} ] [ \begin{matrix}{\hat{s}}_{1} \\ {\hat{s}}_{2} \\ ⋮ \\ {\hat{s}}_{j} \\ ⋮ \\ {\hat{s}}_{{N}_{T}}\end{matrix} ] = W \hat{s} = WPs \qquad [ Formula 5 ]$$

Generally, a physical meaning of a rank of a channel matrix may indicate a maximum number for carrying different informations on a granted channel. Since a rank of a channel matrix is defined as a minimum number of the numbers of independent rows or columns, a rank of a channel is not greater than the number of rows or columns. For example by formula, a rank of a channel H (i.e., rank (H)) is limited by Formula 6.

rank(H)≦min(N_{T},N_{R}) [Formula 6]

Meanwhile, each different information sent by MIMO technology may be defined as ‘transport stream’ or ‘stream’ simply. This ‘stream’ may be called a layer. If so, the number of transport streams is unable to be greater than a channel rank, which is the maximum number for sending different informations. Hence, the channel matrix H may be represented as Formula 7.

# of streams≦rank(H)≦min(N_{T},N_{R}) [Formula 7]

In this case, of streams' may indicate the number of streams. Meanwhile, it should be noted that one stream is transmittable via at least one antenna.

Various methods for making at least one stream correspond to several antennas may exist. These methods may be described in accordance with a type of MIMO technique as follows. First of all, if one stream is transmitted via several antennas, it may be regarded as spatial diversity. If several streams are transmitted via several antennas, it may be regarded as spatial multiplexing. Of course, such an intermediate type between spatial diversity and spatial multiplexing as a hybrid type of spatial diversity and spatial multiplexing may be possible.

As one example of spatial diversity scheme, STBC (space-time block coding) or STC (space time coding) has been acknowledged as efficient way to reduce interference.

According to STBC scheme, one transmission symbol is transmitted via multiple resources, but the transmission power for one transmission of symbol is reduce such that the total transmission power for that symbol remains the same. When there are two transmission symbols S₀ and S₁ and they are transmitted with STBC scheme, the received signals can be expressed as:

Y(k)=H(k)(S₀/\sqrt{2}+S₁/\sqrt{2})+N(k)

Y(k+1)=H(k+1)(−S₀*/\sqrt{2}+S₁*/\sqrt{2})+N(k+1) [Formula 8]

Here, ‘k’ may represent an index of time domain unit.

The receiving side device may decode the received signals by combining the above signals. By doing this, transmission diversity gain can be achieved.

$${S}_{0} = \begin{matrix}\frac{{\vert H ( k ) \vert}^{2} + {\vert H ( k + 1 ) \vert}^{2}}{2}\end{matrix} + \frac{H ( k ) N ( k ) + {H}^{*} ( k + 1 ) N ( k + 1 )}{\sqrt{2}} \qquad [ Formula 9 ]$$

The above explained STBC scheme is more efficient way for communication when it is used within multi-cell environment. When the channel and symbols are expressed as the same as Formulas 8 and 9, and when the channel from neighboring cell is expressed by ‘G’ and signals transmitted from neighboring cell are expressed as ‘X₀ and X₁’, the received signals and combined signal can be expressed as:

$$Y ( k ) = H ( k ) ( {S}_{0} / \sqrt{2} + {S}_{1} / \sqrt{2} ) + G ( k ) ( {X}_{0} / \sqrt{2} + {X}_{1} / \sqrt{2} ) + N ( k ) \\ Y ( k + 1 ) = H ( k + 1 ) ( - {S}_{0}^{*} / \sqrt{2} + {S}_{1}^{*} / \sqrt{2} ) + G ( k + 1 ) ( - {X}_{0}^{*} / \sqrt{2} + {X}_{1}^{*} / \sqrt{2} ) + N ( k + 1 ) \\ {S}_{0} = \frac{{\vert H ( k ) \vert}^{2} + {\vert H ( k + 1 ) \vert}^{2}}{2} + \begin{matrix}\frac{\begin{matrix}{H}^{*} ( k ) G ( k ) {X}_{0} + {H}^{*} ( k ) G ( k ) {X}_{1} + H ( k + 1 ) - \\ H ( k + 1 ) G ( k + 1 ) {X}_{0}^{*} + H ( k + 1 ) G ( k + 1 ) {X}_{1}^{*}\end{matrix}}{2}\end{matrix} + \frac{{H}^{*} ( k ) N ( k ) + H ( k + 1 ) N ( k + 1 )}{\sqrt{2}} \qquad [ Formula 10 ]$$

The following can be exemplary ways for increasing diversity gain to reduce interference.

Example 1) SISO→STBC/SFBC: it can be used when there are 2 or 4 transmission antennas

Example 2) Single Layer Beamforming→Dual Layer Beamforming+STBC/SFBC: it can be used when the receiving side device can divide the 2 received signals

Example 3) Symbol Spreading: it can also be used for single antenna transmission like DFT-s-OFDM or CDMA.

Hereinafter, a Massive MIMO scheme will be explained.

LTE system has supported up to 8 Tx antennas. But, in 5G communication system, the Massive MIMO scheme will be employed for increasing transmission rate and energy efficiency. By using massive Tx antenna, the receiving side device may successfully decode the received signals even when the signals are transmitted with low transmission rate. Also, the transmission rate can be increased due to the massive Tx antennas. Exact threshold for the number of Tx antennas for Massive MIMO is not determined, but it is obvious that the number of Tx antennas are more than 8, and the study for massive MIMO system suppose much more number of Tx antennas.

In the LTE system, the feedback information for each of ranks should be transmitted by the receiving side device. For example, when the transmitting side device transmits Rank 1 or Rank 2 signals with SFBC scheme, the receiving side device calculate each of CQI as following:

$$Rank \text{-} 1 C Q I \text{:} S N R = \frac{{\vert {H}_{1} \vert}^{2} + {\vert {H}_{2} \vert}^{2}}{2 {σ}^{2}} \\ Rank \text{-} 2 C Q I \text{:} S N R = \frac{{\vert {Heq}_{1} \vert}^{2}}{{\vert {Heq}_{2} \vert}^{2} + {σ}^{2}} \qquad [ Formula 11 ]$$

And, the transmitting side device may change the transmission scheme for transmitting different rank signals. For example, when the transmitting side device transmits Rank 1 signal, it may use precoder 1 corresponding to precoding matrix 1. And it may transmit Rank 2 signal by using precoder 2 corresponding to precoding matrix 2. In response, the receiving side device would transmit the feedback information for each of Rank 1 signal and Rank 2 signals as:

(1) Rank 1: Precoder indication (2 or 4 bits), CQI for Rank 1 (4 bits)

(2) Rank 2: Precoder indication (1 or 4 bits), CQI for Rank 2 (7 bits)

When the Massive MIMO scheme is employed for 5G technology, the transmission rank of the signals would be increase. So, the above feedback information transmission would significantly increase the signaling overhead, and/or delay the communication.

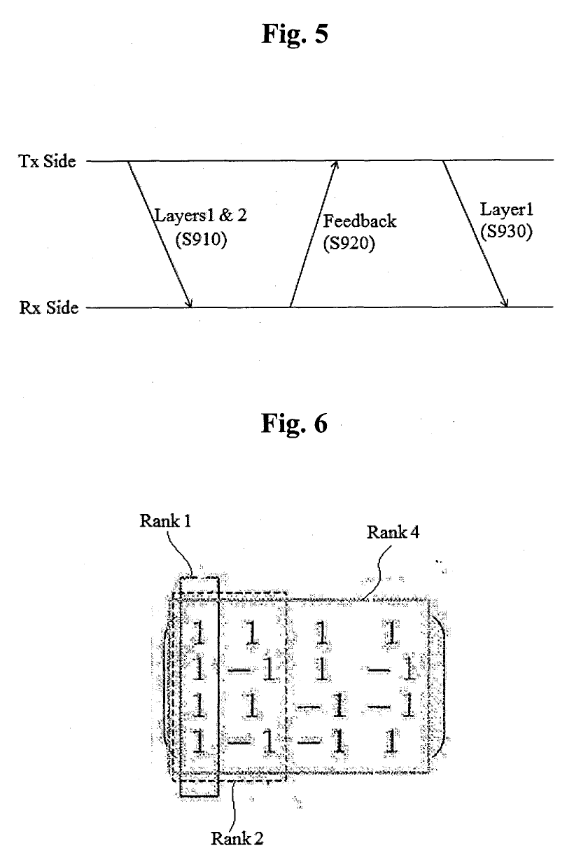

FIG. 5 is a diagram for explaining the use of common feedback information according to one embodiment of the present application.

In FIG. 5, the transmitting side device (Tx side) may comprises multiple antennas. At step S910, Tx side device may transmit rank Ni signals to a receiving side device (Rx side device) with a first type multiple antenna transmission scheme. In this example, suppose Ni=2, and the first type multiple antenna transmission scheme is precoding with precoding matrix 1. In response to this, the Rx side device may transmit feedback information (S920). In this embodiment, the feedback information is common feedback information for all rank transmission. So, this common feedback information comprises feedback information for rank 1 and rank 2.

The Tx side device may transmit rank Nj signals to the receiving side device with a second type multiple antenna transmission scheme at S920, where Ni>Nj. In FIG. 5, the Nj=1, and suppose that the second type multiple antenna transmission scheme is a precoding with precoding matrix 2.

Since the feedback information received at S920 is common feedback information for all ranks, the transmission of layer 1 signal at step 930 would be made in consideration of the corresponding part of the feedback information.

In order to achieve this, at one aspect of the present invention, the Tx side device may use the same type of multiple antenna transmission scheme for corresponding rank signal transmission. That is, the first type multiple antenna transmission scheme may use the second type multiple antenna transmission scheme for transmitting rank Nj signals among the transmitted rank Ni signals at S910. For example, the first precoding matrix may include all column of the second precoding matrix. It will be explained with regards to FIG. 6.

FIG. 6 is a diagram for explaining the sub-combination relationship between the first and the second multiple antenna transmission schemes.

As stated above, it is preferable that the first precoding matrix for the higher rank comprises all the columns of the second precoding matrix for the lower rank. In FIG. 6, suppose the first precoding matrix is for Rank 4 transmission. And, suppose the second precoding matrix is Rank 2 transmission or Rank 1 transmission. As shown in FIG. 6, the first precoding matrix includes all the column of the second precoding matrix, so the feedback information for Rank 4 transmission can be reused based on the corresponding part of the feedback information for Rank 2/1 transmission.

The multiple antenna transmission schemes may not be restricted to a specific precoding scheme embodied with precoding matrix. As another example, where Ni is 2 and Nj is 1, the first type multiple antenna transmission scheme may be a dual stream beamforming, and the second type multiple antenna scheme may be an Alamouti transmission based on the same dual stream beamforming.

By using this scheme, the feedback overhead may be efficiently reduced.

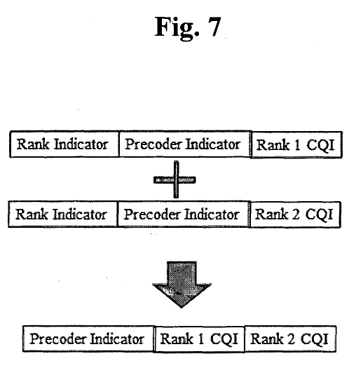

FIG. 7 is a diagram for explaining the reduction of feedback information according to one embodiment of the present invention.

As stated above, according to the LTE standard, the feedback information shall be transmitted for each rank. So, the feedback information for rank 1 signal would have the format of:

Rank Indicator (1 bit), precoder index (4 bits), and Rank 1 CQI (4 bits)

So, total 9 bits are required for Rank 1 feedback information.

And, the feedback information for rank 2 signal would have the format of:

Rank Indicator (1 bit), precoder index (4 bits), and Rank 2 CQI (7 bits)

So, total 12 bits are required for rank 2 feedback information.

But, by using the above explained scheme according to one embodiment of the present invention, the common feedback information may have the format of:

Precoder Indicator (4 bits), Rank 1 CQI (4 bits), and Rank 2 CQI (7 bits)

So, total 15 bits are required for common feedback information of the present embodiment.

In order to realize this, it is preferable that the selection sequence of layers for each rank is predetermined. For example, when there is a rank 2 transmission, the layers 0 and 1 are transmitted column 0 and 1 among the precoding matrix is used. Based on this, there will be no need for additional control information for indicating the mapping relationship between specific layers and the CQI.

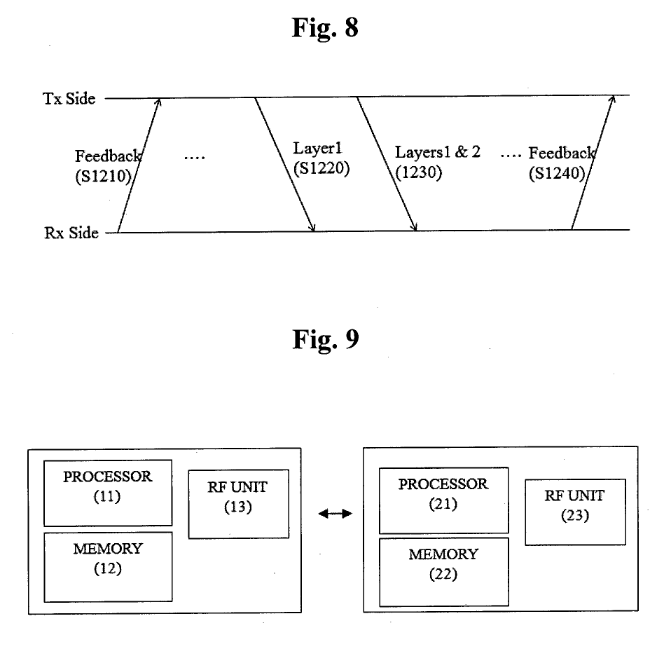

FIG. 8 is a diagram for explaining another example of present invention.

Basic concept of this example is the same as in FIG. 5. That is, the first type multiple antenna transmission scheme for higher rank uses the same scheme (second type multiple antenna transmission scheme for lower layer) for corresponding part of the layer(s). But, in FIG. 8, the sequence of each step is different from those of FIG. 6.

At S1220, the Tx side device may transmit layer 1 as Rank 1 transmission with the second type multiple antenna transmission scheme. And, the Tx side device may transmit layers 1 and 2 as Rank 2 transmission with the first type multiple antenna transmission scheme. As stated above, the first and the second multiple antenna transmission schemes meet the sub-combination relationship with each other.

The Rx side device may transmit common feedback information based on the received signal at two steps. This common feedback information may comprise both of Rank 1 feedback information and Rank 2 feedback information. If the transmission rank is generalized as Ni and Nj, which are not greater than the maximum number of Rank, the feedback information may comprise a combination of feedback information for all ranks.

This feedback information may be reported with predetermined period. For example, the feedback information reporting at S1210 and S1240 may be based on a predetermined period. Between these instances for feedback information reporting, any number of receptions of signals may be performed.

The above explained scheme would efficiently reduce the feedback overhead when the Massive MIMO scheme is employed.

FIG. 9 is a block diagram for a configuration of a communication device according to one embodiment of the present invention.

Referring to FIG. 9, a communication device may be configured by including a processor 11, a memory 12 and an RF module 13. The communication device can communicate with a different communication device that includes the above-mentioned configuration 21, 22 and 23.

One communication device shown in FIG. 9 may include a UE, while the other may include a base station. The communication device shown in FIG. 9 is illustrated for clarity of the description and modules included in the communication device may be omitted in part. And, the communication device may further include necessary module(s).

The processor 11/21 in the communication device can perform most of controls for implementing the above-described methods according to the embodiments of the present invention. The memory 12/22 is connected to the processor 11/21 so as to store necessary information. The RF unit 13/23 transceives radio signals and is able to forward them to the processor 11/21. One or more of RF units 13 and 23 may be connected to/include multiple antennas.

The above-described embodiments may correspond to combinations of elements and features of the present invention in prescribed forms. And, it may be able to consider that the respective elements or features may be selective unless they are explicitly mentioned. Each of the elements or features may be implemented in a form failing to be combined with other elements or features. Moreover, it may be able to implement an embodiment of the present invention by combining elements and/or features together in part. A sequence of operations explained for each embodiment of the present invention may be modified. Some configurations or features of one embodiment may be included in another embodiment or can be substituted for corresponding configurations or features of another embodiment.

Embodiments of the present invention can be implemented using various means. For instance, embodiments of the present invention can be implemented using hardware, firmware, software and/or any combinations thereof. In case of the implementation by hardware, one embodiment of the present invention can be implemented by at least one selected from the group consisting of ASICs (application specific integrated circuits), DSPs (digital signal processors), DSPDs (digital signal processing devices), PLDs (programmable logic devices), FPGAs (field programmable gate arrays), processor, controller, microcontroller, microprocessor and the like.

In case of the implementation by firmware or software, a method according to each embodiment of the present invention can be implemented by modules, procedures, and/or functions for performing the above-explained functions or operations. Software code is stored in a memory unit and is then drivable by a processor. The memory unit is provided within or outside the processor to exchange data with the processor through the various means known to the public.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

The above explained communication scheme can be used in various wireless communication system, such as IEEE 802.11 system, 802.16 system, LTE/LTE-A and 5G communication system.

1. A method for a transmitting side device to transmit signals with multiple antennas in a wireless communication system, the method comprising:
transmitting rank Ni signals to a receiving side device with a first type multiple antenna transmission scheme at a first transmission opportunity;
receiving feedback information from the receiving side device in response to the transmitted rank Ni signals;
transmitting rank Nj signals to the receiving side device with a second type multiple antenna transmission scheme at a second transmission opportunity, wherein Ni>Nj,
wherein the first type multiple antenna transmission scheme uses the second type multiple antenna transmission scheme for transmitting rank Nj signals among the transmitted rank Ni signals at the first transmission opportunity, and
wherein transmitting the Nj signals at the second transmission opportunity is based on a consideration of a part of the feedback information received in response to the rank Ni signals transmitted at the first transmission opportunity.

2. The method of claim 1, wherein Ni is 2 and Nj is 1, wherein the first type multiple antenna transmission scheme is dual stream beamforming, and wherein the second type multiple antenna scheme is Alamouti transmission based on the dual stream beamforming.

3. The method of claim 1, wherein the first type multiple antenna transmission scheme uses a first precoder corresponding to a first precoding matrix,
wherein the second type of multiple antenna transmission scheme uses a second precoder corresponding to a second precoding matrix, and
wherein the first precoding matrix comprises all of columns of the second precoding matrix.

4. The method of claim 3, wherein the feedback information comprises:
an index indicating the first precoding matrix,
channel quality information for the rank Ni signals, and
channel quality information for the rank Nj signals.

5. The method of claim 1, wherein the feedback information comprises a combination of a first feedback information for the rank Ni signals and a second feedback information for the rank Nj signals.

6. The method of claim 1, wherein the transmitting side device comprises Nk transmission antennas, and
wherein Ni is an integer from 2 to Nk.

7. The method of claim 1, wherein the transmitting side device comprises a base station employing a massive MIMO scheme.

8. A method for a receiving side device to transmit feedback information in a wireless communication system, the method comprising:
receiving rank Ni signals from a transmitting side device with a first type multiple antenna transmission scheme at a first receiving opportunity;
receiving rank Nj signals from the transmitting side device with a second type multiple antenna transmission scheme at a second receiving opportunity, wherein Ni>Nj; and
transmitting feedback information to the transmitting side device,
wherein the first type multiple antenna transmission scheme uses the second type multiple antenna transmission scheme for transmission of rank Nj signals among the rank Ni signals received at the first receiving opportunity, and
wherein the feedback information comprises a combination of a first feedback information for the rank Ni signals and a second feedback information for the rank Nj signals.

9. The method of claim 8, wherein the first type multiple antenna transmission scheme uses a first precoder corresponding to a first precoding matrix,
wherein the second type of multiple antenna transmission scheme uses a second precoder corresponding to a second precoding matrix, and
wherein the first precoding matrix comprises all of columns of the second precoding matrix.

10. An transmitting side device for transmitting signals in a wireless communication system, the device comprising:
multiple antennas;
a RF unit in connection with the multiple antennas; and
a processor connected to the RF unit and configured to control the RF unit to transmit rank Ni signals with a first type multiple antenna transmission scheme, and to transmit rank Nj signals with a second type multiple antenna transmission scheme, and to receive feedback information from a receiving side device,
wherein Ni>Nj, wherein the first type multiple antenna transmission scheme uses the second type multiple antenna transmission scheme for transmitting rank Nj signals among the rank Ni signals at a transmission of the rank Ni signals, and
wherein transmitting independent Nj signals is based on a consideration of a part of the feedback information received in response to the previously transmitted rank Ni signals.

11. The device of claim 10, wherein the first type multiple antenna transmission scheme uses a first precoder corresponding to a first precoding matrix,
wherein the second type of multiple antenna transmission scheme uses a second precoder corresponding to a second precoding matrix, and
wherein the first precoding matrix comprises all of columns of the second precoding matrix.

12. The device of claim 10, wherein the feedback information comprises a combination of a first feedback information for the rank Ni signals and a second feedback information for the rank Nj signals.

13. A receiving side device for transmitting feedback information in a wireless communication system, the device comprising:
a RF unit receiving rank Ni signals from a transmitting side device with a first type multiple antenna transmission scheme, and receiving rank Nj signals from the transmitting side device with a second type multiple antenna transmission scheme, wherein Ni>Nj; and and transmitting feedback information to the transmitting side device, wherein the first type multiple antenna transmission scheme uses the second type multiple antenna transmission scheme for transmission of rank Nj signals among the rank Ni signals; and
a processor connected to the RF unit and configured to construct the feedback information to comprise a combination of a first feedback information for the rank Ni signals and the rank Nj signals.

14. The device of claim 13, wherein the first type multiple antenna transmission scheme uses a first precoder corresponding to a first precoding matrix,
wherein the second type of multiple antenna transmission scheme uses a second precoder corresponding to a second precoding matrix, and
wherein the first precoding matrix comprises all of columns of the second precoding matrix.
